(19) United States
(12) Patent Application Publication
(10) Pub. No.: US 2007/0137522 A1
(43) Pub. Date: Jun. 21, 2007

(54) Yellow dyes and ink compositions comprising the same

(75) Inventors: Hsiu-Ting Chen, Taipei County (TW); Yun-I Liu, Taoyuan Hsien (TW); Yen-Huang Hsu, Hsinchu County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/637,712

(22) Filed: Dec. 13, 2006

(30) Foreign Application Priority Data
Dec. 15, 2005 (TW) 94144443

(51) Int. Cl. C09D 11/00

(52) U.S. Cl. 106/31.27; 106/31.58; 106/31.59

(57) ABSTRACT

A yellow dye. The yellow dye is an ionic compound including lithium ions and sodium ions. The invention also provides an ink composition including the yellow dye.

### BACKGROUND OF THE INVENTION

1. Field of the Invention

The invention relates to a dye, and in particular to a yellow dye and an ink composition comprising the same.

2. Description of the Related Art

Injet printing has been developing for many years. Printers employing such technology are inexpensive, quiet, and suitable for use with various carriers such as paper and film, and provide quality full-color printing.

Injet printing is a non-contact technique in which ink droplets are injected onto carriers. Generally, the characteristics of ink composition and printing quality must meet the following requirements: ink feathering or bleeding does not occur on carriers; ink dries rapidly; nozzle clogging does not occur during long-term use; ink has high storage stability; ink is non-toxic and safe.

To meet the above requirements, various additives such as humectants, amphoteric surfactants, non-ionic surfactants, or buffers may be added.

It is difficult to meet prevent nozzle clogging, however, as yellow dyes suffer from high crystallization, resulting in yellow crystals formation on the nozzle surface after a cartridge is idle for a long period.

If the idle time is shorter, the formed thin and soft crystals can be simply wiped away. If the idle time is longer, however, a thick, dried, and hard crystal layer is formed on nozzle surface. Thus, anti-crystallizing yellow dyes are required.

Some anti-crystallizing yellow dyes, however, may also reduce the available color gamut, causing print quality to suffer.

### BRIEF SUMMARY OF THE INVENTION

The invention provides a yellow dye, an ionic compound comprising lithium ions and sodium ions.

The invention also provides an ink composition comprising the disclosed yellow dye and a solvent.

A detailed description is given in the following.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a yellow dye, an ionic compound comprising lithium ions and sodium ions.

Compared to related direct yellow dye 132 containing sodium ions only, the yellow dye 132 of the invention comprises both lithium ions and sodium ions. The ratio of lithium ions and sodium ions is about 0.1:99.9˜90:10, preferably 10:90˜40:60.

The disclosed yellow dye, an ionic compound containing lithium ions and sodium ions, provides higher dissolvability and lower crystallization due to higher dissolvability of lithium salt than sodium salt.

The invention also provides an ink composition comprising the disclosed yellow dye and a solvent.

In the ink composition, the yellow dye has a weight ratio of about 0.1˜10%, preferably 2˜8%. The solvent may be water and have a weight ratio of about 50˜95%, preferably 70˜90%.

The ink composition may comprise only one yellow dye or one or more other dyes such as yellow dye 132 or yellow dye 86, depending on practical requirements. Additionally, the ink composition may further comprise one or more additives, such as humectants, surfactants, buffers, organic solvents, chelating agents, bactericides, preservatives, UV blockers, or dispersants. The humectants may be ethylene glycol, diethylene glycol, or glycerol, and have a weight ratio of about 10˜30%. The surfactants may be anionic, cationic, non-ionic, or amphoteric, and have a weight ratio less than 20%.

The surfactants added can reduce surface tension and increase latency of ink, facilitating ink supply and injection. Generally, one or more surfactants can be added.

For humectants, low volatility and high dissolvability in main solvent are required to reduce precipitates or crystals, avoiding nozzle blockage.

Furthermore, UV blockers may be added to prevent UV absorption, increasing lightfastness of dyes. Bactericides may be added to inhibit bacteria growth. Dispersants may be added to increase dispersibility of substances in ink. Chelating agents may be added to prevent crystal salt formation. Buffers may also be added to exhibit desirable colors in specific pH ranges.

Besides low crystallization, the ink also provides high latency due to addition of the novel yellow dye and other additives, avoiding inferior printing quality after idling for a long period. The modified direct yellow dye also maintains the original color gamut.

### EXAMPLE 1

The invention provides five ink compositions (compositions 1˜5, containing yellow dyes with various ratios of lithium ions and sodium ions) to test latency and crystallization of ink.

The ink composition 1 contains 0.5% direct yellow dye 86, 2.5% direct yellow dye 132 (100% sodium ions), 70% water, buffer, chelating agent, bactericide, and preservative.

Latency Test

After filling the ink composition 1 into the cartridge, printing was immediately performed. After printing, the cartridge was removed and kept idle for one week (room temperature, 1 atm, and 70% humidity). Finally, the cartridge was placed back into the printer and printing was performed again.

Crystallization Test

After filling the ink composition 1 into the cartridge, printing was immediately performed. After printing, the cartridge was removed and kept idle for one week (room temperature, 1 atm, and 70% humidity). Finally, the nozzle surface was observed to determine whether or not yellow crystallization was formed thereon.

### EXAMPLE 2

The ink composition 2 contains 0.5% direct yellow dye 86, 2.5% direct yellow dye 132 (20% lithium ions and 80% sodium ions), 70% water, buffer, chelating agent, bactericide, and preservative.

Latency Test

After filling the ink composition 2 into the cartridge, printing was immediately performed. After printing, the cartridge was removed and kept idle for one week (room temperature, 1 atm, and 70% humidity). Finally, the cartridge was placed back into the printer and printing was performed again.

Crystallization Test

After filling the ink composition 2 into the cartridge, printing was immediately performed. After printing, the cartridge was removed and kept idle for one week (room temperature, 1 atm, and 70% humidity). Finally, the nozzle surface was observed to determine whether or not yellow crystallization was formed thereon.

### EXAMPLE 3

The ink composition 3 contains 0.5% direct yellow dye 86, 2.5% direct yellow dye 132 (50% lithium ions and 50% sodium ions), 70% water, buffer, chelating agent, bactericide, and preservative.

Latency Test

After filling the ink composition 3 into the cartridge, printing was immediately performed. After printing, the cartridge was removed and kept idle for one week (room temperature, 1 atm, and 70% humidity). Finally, the cartridge was placed back into the printer and printing was performed again.

Crystallization Test

After filling the ink composition 3 into the cartridge, printing was immediately performed. After printing, the cartridge was removed and kept idle for one week (room temperature, 1 atm, and 70% humidity). Finally, the nozzle surface was observed to determine whether or not yellow crystallization was formed thereon.

### EXAMPLE 4

The ink composition 4 contains 0.5% direct yellow dye 86, 2.5% direct yellow dye 132 (70% lithium ions and 30% sodium ions), 70% water, buffer, chelating agent, bactericide, and preservative.

Latency Test

After filling the ink composition 4 into the cartridge, printing was immediately performed. After printing, the cartridge was removed and kept idle for one week (room temperature, 1 atm, and 70% humidity). Finally, the cartridge was placed back into the printer and printing was performed again.

Crystallization Test

After filling the ink composition 4 into the cartridge, printing was immediately performed. After printing, the cartridge was removed and kept idle for one week (room temperature, 1 atm, and 70% humidity). Finally, the nozzle surface was observed to determine whether or not yellow crystallization was formed thereon.

### EXAMPLE 5

The ink composition 5 contains 0.5% direct yellow dye 86, 2.5% direct yellow dye 132 (90% lithium ions and 10% sodium ions), 70% water, buffer, chelating agent, bactericide, and preservative.

Latency Test

After filling the ink composition 5 into the cartridge, printing was immediately performed. After printing, the cartridge was removed and kept idle for one week (room temperature, 1 atm, and 70% humidity). Finally, the cartridge was placed back into the printer and printing was performed again.

Crystallization Test

After filling the ink composition 5 into the cartridge, printing was immediately performed. After printing, the cartridge was removed and kept idle for one week (room temperature, 1 atm, and 70% humidity). Finally, the nozzle surface was observed to determine whether or not yellow crystallization was formed thereon.

After idling for a long period, ink with low latency may be over vaporized, causing increased viscosity and inferior printing quality. Here, we use “miss nozzle” to represent printing quality. As the “miss nozzle” increases, the printing quality worsens. Simultaneously, whether crystals were formed or not on the nozzle surface is also observed.

Compared to crystallization degrees of the five yellow ink compositions (1˜5) on the nozzle surface, crystal formation is effectively inhibited due to increased lithium ions.

According to the numbers of openings of nozzle patterns on carriers, three conclusions are obtained.

(1) For all ink compositions, at the first printing, all of the nozzle patterns are opened.

(2) After the cartridge is idle for one week under normal conditions, various ink compositions result in various opening numbers of nozzles. When the ratio of lithium ions and sodium ions is 20:80, all of the nozzles are still opened. For other ink compositions, however, “miss nozzle” exists. The increased “miss nozzle” represents low latency of ink.

(3) After the cartridge is idled for one week in normal condition, lithium ions can inhibit yellow crystallization, even only 20% added.

The results are recited in table 1.

TABLE 1

| | Composition 1 | Composition 2 | Composition 3 | Composition 4 | Composition 5 |
|---|---|---|---|---|---|
| Lithium/Sodium | 0/100 | 20/80 | 50/50 | 70/30 | 10/90 |
| Opening degree | Fully opened | Fully opened | Fully opened | Fully opened | Fully opened |
| (one week | | | | | |
| before) | | | | | |
| Opening degree | Partly opened | Fully opened | Partly opened | Partly closed | Fully closed |
| (one week after) | | | | | |
| Crystallization | Yes | Non | Non | Non | Non |
| (one week after) | | | | | |

The results indicate that the yellow dye with added lithium ions can effectively inhibit crystallization. Excessive lithium ions, however, may reduce latency thereof, particularly after being idle for a long period of time, and the “miss nozzle” issue become more serious (see compositions 3˜5).

The invention replaces partial sodium ions with lithium ions to form an ionic compound mixing with lithium salt and sodium salt and provides a proper ratio therebetween to avoid crystallization and maintain ink latency, significantly improving printing quality. Preferably, the ratio of lithium ions and sodium ions is 20:80.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A yellow dye, an ionic compound comprising lithium ions and sodium ions.

2. The yellow dye as claimed in claim 1, wherein the yellow dye is a direct yellow dye.

3. The yellow dye as claimed in claim 1, wherein the lithium ions and sodium ions have a ratio of about 0.1:99.9˜90:10.

4. The yellow dye as claimed in claim 1, wherein the lithium ions and sodium ions have a ratio of about 10:90˜40:60.

5. An ink composition, comprising:
a yellow dye as claimed in claim 1; and
a solvent.

6. The ink composition as claimed in claim 5, wherein the yellow dye has a weight ratio of about 0.1˜10%.

7. The ink composition as claimed in claim 5, wherein the yellow dye has a weight ratio of about 2˜8%.

8. The ink composition as claimed in claim 5, wherein the solvent comprises water.

9. The ink composition as claimed in claim 5, wherein the solvent has a weight ratio of about 50˜95%.

10. The ink composition as claimed in claim 5, wherein the solvent has a weight ratio of about 70˜90%.

11. The ink composition as claimed in claim 5, further comprising one or more dyes.

12. The ink composition as claimed in claim 5, further comprising one or more additives.

13. The ink composition as claimed in claim 12, wherein the additives comprise humectants, surfactants, buffers, organic solvents, chelating agents, bactericides, preservatives, UV blockers, or dispersants.

14. The ink composition as claimed in claim 13, wherein the humectants comprise ethylene glycol, diethylene glycol, or glycerol.

15. The ink composition as claimed in claim 13, wherein the humectant has a weight ratio of about 10˜30%.

16. The ink composition as claimed in claim 13, wherein the surfactants are anionic, cationic, non-ionic, or amphoteric surfactants.

17. The ink composition as claimed in claim 13, wherein the surfactant has a weight ratio less than 20%.
